(19) United States
(12) Patent Application Publication
(10) Pub. No.: US 2023/0362943 A1
(43) Pub. Date: Nov. 9, 2023

(54) SCHEDULING RESTRICTION ENHANCEMENT FOR LTE AND NR DSS

(71) Applicant: Apple Inc., Cupertino, CA (US)

(72) Inventors: Haitong SUN, Cupertino, CA (US); Chunxuan YE, San Diego, CA (US); Dawei ZHANG, Saratoga, CA (US); Hong HE, San Jose, CA (US); Huaning NIU, San Jose, CA (US); Jie CUI, San Jose, CA (US); Wei ZENG, Saratoga, CA (US); Weidong YANG, San Jose, CA (US); Yang TANG, San Jose, CA (US); Yushu ZHANG, Beijing (CN)

(73) Assignee: Apple Inc., Cupertino, CA (US)

(21) Appl. No.: 17/441,154

(22) PCT Filed: Jan. 15, 2021
(86) PCT No.: PCT/CN2021/072109

§ 371 Date: Sep. 20, 2021

(51) Int. Cl. H04W 72/23; H04L 1/1822; H04L 1/1867; H04L 5/00; H04W 72/12

(52) U.S. Cl. CPC H04W 72/23; H04L 1/1822; H04L 1/1887; H04L 5/0053; H04W 72/12; H04W 16/14

(57) ABSTRACT

Apparatuses, systems, and methods for supporting cross carrier scheduling in LTE and NR dynamic spectrum sharing (DSS). A cellular base station may generate control information in accordance with a set of criteria, wherein the set of criteria supports a special Secondary Cell (sSCell) which is a Secondary Cell (SCell) in scheduling a special Primary Cell (SpCell) which is either a Primary Cell (PCell) or a Primary Secondary Cell (PSCell). The cellular base station sends the control information to a wireless device. The control information may be associated with Type3-PDCCH CSS configuration including DCI Format 2_5 and 2_6, SCell dormancy behavior, scheduling restrictions, USS configuration including non-fallback and fallback DCI Formats, and interaction with Multi-DCI Multi-TRP operation. After receiving the control information, the wireless device may conduct corresponding performance.

### FIELD

The present application relates to wireless communications, and more particularly to apparatus, systems, and methods for supporting cross carrier scheduling (CCS).

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including fifth generation (5G) new radio (NR) communication. Accordingly, improvements in the field in support of such development and design are desired.

### SUMMARY

LTE and NR dynamic spectrum sharing (DSS) allows LTE and NR to be deployed in the same spectrum. Normally, LTE has always on cell-specific reference signal (CRS) in every slot (1 slot may comprise 14 symbols). For example, when LTE has 1 or 2 port CRS, CRS occupies symbol {0, 4, 7, 11}; and when LTE has 4 port CRS, CRS occupies symbol {0, 1, 4, 7, 8, 11}. Since NR CORESET only rates match with LTE CRS at symbol level, thus for most of the time, this prevents NR from configuring 3 symbol CORESET, or many times, 2 symbol CORESET. Therefore, NR scheduling flexibility and control reliability are significantly limited. In order to solve this problem, cross carrier scheduling attracts increasing attentions to enhance NR scheduling flexibility and control reliability. Current cross carrier scheduling (CSS) has several restrictions, such as there is no cross Cell Group (CG) cross carrier scheduling; Primary Cell (PCell) can only be scheduled by itself; and for each scheduled cell, only one scheduling cell can be Radio Resource Control (RRC) configured to schedule it.

According to Rel-17 DSS enhancement, it was agreed to consider a special Primary Cell (SpCell) which is either a Primary Cell (PCell) for a Master Cell Group (MCG) or a Primary Secondary Cell (PSCell) for a Secondary Cell Group (SCG) to be scheduled by a special Secondary Cell (sSCell) which is a Secondary Cell (SCell). That is, in addition to an SpCell scheduling itself, an sSCell could also schedule the SpCell. The sSCell may be in the same CG with the SpCell.

Currently, in RAN 1103e, limited progress has made regarding supporting sSCell in scheduling SpCell. Therefore, the present disclosure is directed to several remaining design details that are still under discussion and unresolved for sSCell scheduling SpCell.

Embodiments in the present disclosure relate to apparatuses, systems, and methods for supporting cross carrier scheduling (CCS), and particularly for supporting sSCell scheduling SpCell.

According to the techniques described herein, a cellular base station may generate control information in accordance with a set of criteria, wherein the set of criteria supports an sSCell which is an SCell in scheduling an SpCell which is either a PCell or a PSCell. The cellular base station sends the control information to a wireless device. The control information and related contents in the set of criteria in the present disclosure are directed to several remaining design details for supporting sSCell scheduling SpCell. For example, the control information may be associated with Type3-PDCCH CSS configuration including DCI Format 2_5 and 2_6, SCell dormancy behavior, scheduling restrictions, USS configuration, and interaction with Multi-DCI Multi-TRP operation.

The wireless device may receive the control information from the cellular base station. After receiving the control information, the wireless device may be configured to conduct corresponding performance.

Thus, the techniques described herein may be used to address several unresolved remaining issues in the scenario where an sSCell schedules an SpCell.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIG. 6 illustrates an example communication system with multiple cells, according to some embodiments;

FIG. 7 is a flowchart diagram illustrating an example method for a cellular base station for supporting sSCell scheduling SpCell, according to some embodiments;

FIG. 8 is a flowchart diagram illustrating an example method for a wireless device for supporting sSCell scheduling SpCell, according to some embodiments;

FIGS. 9-10 are schematic figures illustrating the scheduling restrictions when an SpCell is scheduled by an sSCell, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)— any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™ iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Downlink Control Information (DCI)—The term “DCI” has the full breadth of its ordinary meaning, and at least includes a special set of information which schedules downlink data channel (e.g., physical downlink shared channel (PDSCH)) or uplink data channel (e.g., physical uplink shared channel (PUSCH)). Current DCI has the following types of formats.
Fallback DCI: DCI Format 0_0 and Format 1_0, which do not support cross carrier scheduling;
Non-Fallback DCI: DCI Format 0_1, Format 0_2, Format 1_1 and Format 12, which support cross carrier scheduling;
Special DCI: DCI Format 2_0, 2_1, 2_2, 2_3, 2_4, 2_5, 2_6.

Search Space—refers to a predefined region in which UE perform the blind decoding of DCI. Current search space has the following types:
Type0-PDCCH CSS (Common Search Space): searchSpaceSIB1, searchSpaceZero
Type0A-PDCCH CSS: searchSpaceOtherSystemInformation
Type1-PDCCH CSS: pagingSearchSpace
Type2-PDCCH CSS: ra-SearchSpace
Type3-PDCCH CSS (Only fallback DCI and Special DCI format 2_x are allowed in CSS).
USS (UE-specific Search Space)

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

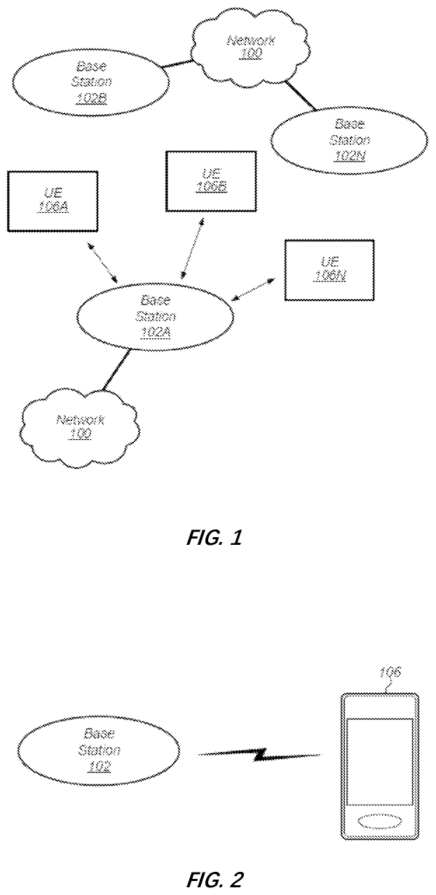

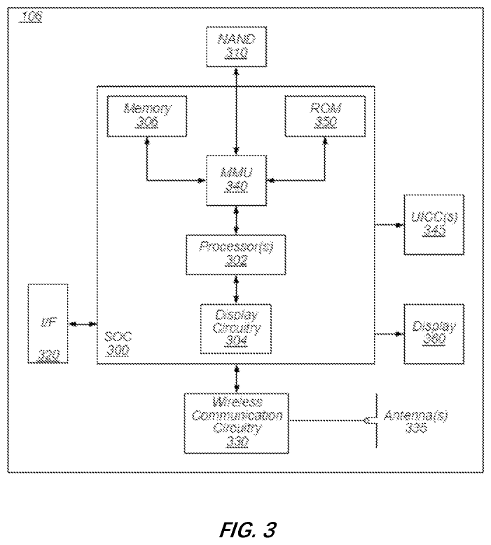

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transmission and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station).

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

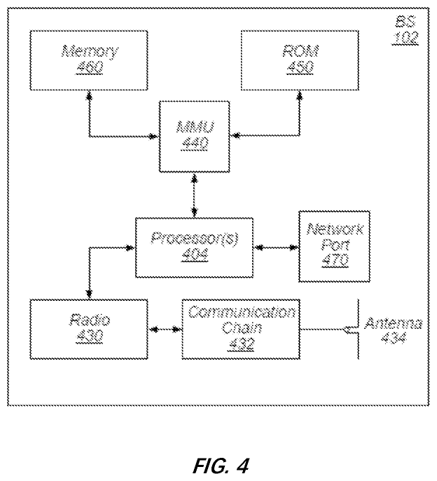

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

FIG. 4— Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

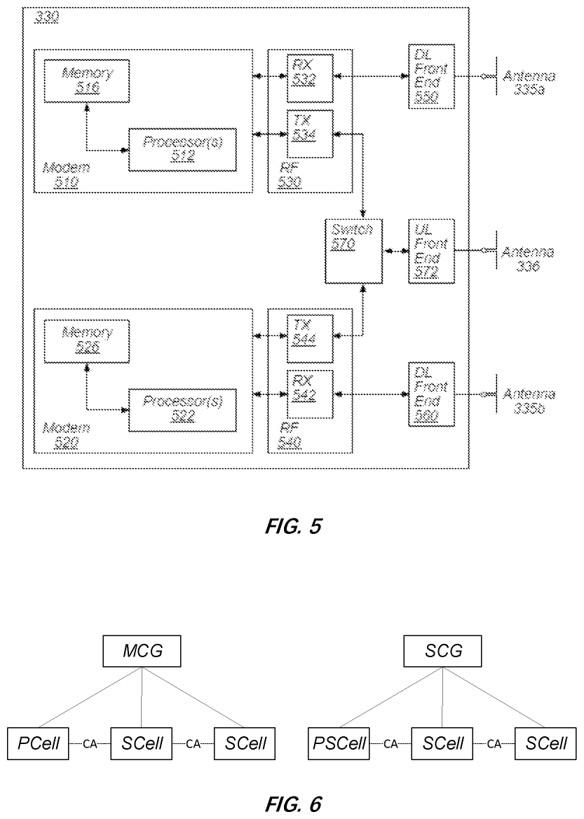

### FIG. 5—Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium). Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

### FIG. 6—Overview of Cells in NR

New cellular communication techniques are continually under development, to increase coverage, to better serve the range of demands and use cases, and for a variety of other reasons. One technique that is currently under development may include cross carrier scheduling. FIG. 6 illustrates an example communication system with multiple cells.

In NR communication system, multiple Cell Groups (CG) may exist. For example, the NR system shown in FIG. 6 comprises two Cell Groups, i.e., Master Cell Group (MCG) and Secondary Cell Group. MCG may comprise one Primary Cell (PCell) and one or more Secondary Cells (SCells), and SCG may comprise one Primary Secondary Cell (PSCell) and one or more Secondary Cells (SCells). In each Cell Group, a cell corresponds to a component carrier, and carrier aggregation may be conducted among multiple cells to enhance overall throughput of the system.

The term “SpCell (special Primary Cell)” may refer to either the PCell in MCG or the PSCell in SCG. The most recent development in cross carrier scheduling allows an SCell to schedule an SpCell, and this SCell may be referred to as “sSCell (special Secondary Cell)”.

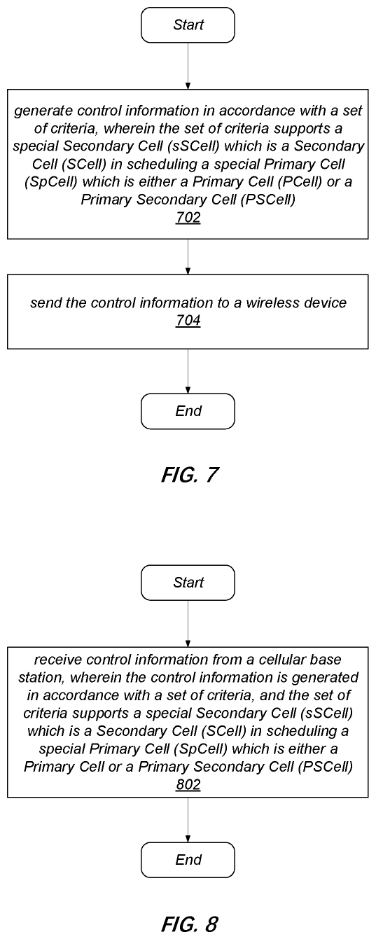

FIGS. 7-8—Method for Supporting sSCell Scheduling SpCell

As part of the development of sSCell scheduling SpCell, it would be useful to provide criteria for downlink control that can support such a technique.

Accordingly, FIGS. 7-8 are flow diagrams illustrating an example method for a cellular base station and an example method for a wireless device, respectively, in order to support sSCell scheduling SpCell, at least according to some embodiments.

Aspects of the method of FIG. 7 may be implemented by a cellular base station such as a BS 102 in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 7 may operate as follows.

At 702, a cellular base station may generate control information in accordance with a set of criteria. The set of criteria supports a special Secondary Cell (sSCell) which is a Secondary Cell (SCell) in scheduling a special Primary Cell (SpCell) which is either a Primary Cell (PCell) or a Primary Secondary Cell (PSCell). At least according to some embodiments, the sSCell and the SpCell are in the same Cell Group (CG). At 704, the cellular base station may send the control information to a wireless device.

Aspects of the method of FIG. 8 may be implemented by a wireless device such as a UE 106 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. As shown, the method of FIG. 8 may operate as follows.

At 802, a wireless device may receive control information from a cellular base station. The control information is generated in accordance with a set of criteria, and the set of criteria supports a special Secondary Cell (sSCell) which is a Secondary Cell (SCell) in scheduling a special Primary Cell (SpCell) which is either a Primary Cell or a Primary Secondary Cell (PSCell). At least according to some embodiments, the sSCell and the SpCell are in the same Cell Group (CG). After receiving the control information, the wireless device may conduct corresponding performance in the scenario of sSCell scheduling SpCell.

It should be understood that in various embodiments, some of the elements of the methods shown may be performed concurrently, in a different order than shown, may be substituted for by other method elements, or may be omitted. Additional elements may also be performed as desired.

The above-mentioned control information and the contents of the set of criteria may be associated with several remaining issues in the scenario of sSCell scheduling SpCell. Five issues are described hereinafter, including Type3-PDCCH CSS configuration including DCI Format 2_5 and 2_6, SCell dormancy behavior, scheduling restrictions, USS configuration, and interaction with Multi-DCI Multi-TRP operation.

### Type3-PDCCH CSS Configuration

Two aspects of Type3-PDCCH CSS (Type3-Physical Downlink Control Channel Common Search Space) configuration are provided.

According to the first aspect, Type3-PDCCH CSS may include DCI Format 2_5. When an SpCell is scheduled by an sSCell, regarding the configuration of DCI Format 2_5 (i.e., DCI with CRC scrambled by AI-RNTI), the following options may be considered:
Option 1: It can be configured in any serving cell (corresponding to any component carrier);
Option 2: It can be configured only in the SpCell;
Option 3: It can be configured only in the sSCell.

According to some embodiments, Option 1 may be the preferred option. That is, it is preferred that a wireless device may be configured by a cellular base station to monitor DCI Format 2_5 configured in any serving cell. It should be understood that DCI Format 2_5 is configured in a cell refers to that DCI Format 2_5 is configured in the component carrier corresponding to the cell, and refers to that the Type3-PDCCH CSS including DCI Format 2_5 is configured in the same component carrier.

It will be appreciated that one of the above options is selected and included in a set of criteria for supporting sSCell scheduling SpCell, according to which control information associated with Type3-PDCCH CSS including DCI Format 2_5 is generated at a cellular base station, and sent to a wireless device.

According to the second aspect, Type3-PDCCH CSS may include DCI Format 2_6. When an SpCell is scheduled by an sSCell, regarding the configuration of DCI Format 2_6 (i.e., DCI with CRC scrambled by PS-RNTI), the following options may be considered:
Option 1: It can be configured only in the SpCell
Option 2: It can be configured only in the sSCell
Option 3: It can be configured either the SpCell or the sSCell, but not both
Option 4: It can be configured either the SpCell or the sSCell and both.

According to some embodiments, Option 1 may be the preferred option. That is, it is preferred that a wireless device may be configured by a cellular base station to monitor DCI Format 2_6 configured only in the SpCell.

It will be appreciated that one of the above options is selected and included in a set of criteria for supporting sSCell scheduling SpCell, according to which control information associated with Type3-PDCCH CSS including DCI Format 2_6 is generated at a cellular base station, and sent to a wireless device.

### SCell Dormancy Behavior

Currently, DCI Format 2_6 (i.e., DCI with CRC scrambled by PS-RNTI) may be configured to fast (DCI triggered) SCell dormancy. DCI Format 2_6 may only be configured in an SpCell, and it does not put the device(s) in the SpCell to dormant.

According to the present disclosure, when an SpCell is scheduled by an SCell, regarding which cell can be triggered to enter dormant operation by DCI Format 2_6, there are the following options:
If DCI Format 2_6 is configured only in the SpCell
Option 1: any cell except the SpCell
Option 2: any cell except the sSCell and the SpCell
If DCI Format 2_6 is configured only in the sSCell
Option 1: any cell except the sSCell and the SpCell
Option 2: any cell except the sSCell
If DCI Format 2_6 is configured in both of the sSCell and the SpCell
Option 1: any cell except the SpCell
Option 2: any cell except the sSCell and the SpCell

According to some embodiments, one option in each pair of options is selected and included in a set of criteria for supporting sSCell scheduling SpCell, to generate a control information sent from a cellular base station to a wireless device. For example, in response to DCI Format 2_6 being scheduled to a wireless device only in the SpCell, a cellular base station may put the wireless device to one of the following: dormant in any cell except the SpCell; and dormant in any cell except the sSCell and the SpCell.

### Scheduling Restrictions

Restrictions on cross carrier scheduling are described in this part. When an SpCell is scheduled by an sSCell, PDSCH transmissions or PUSCH transmissions scheduled by the SpCell and the sSCell should not be out of order (OOO).

### PDSCH Transmission

Normally, DCI scheduling a PDSCH transmission in a cell may correspond to a Hybrid Automatic Repeat request (HARQ) process. According to some embodiments, for any two HARQ process IDs in a given scheduled cell, if a wireless device (e.g., a UE) is scheduled to start an early PDSCH transmission starting in symbol j by DCI scheduled by the SpCell or the sSCell ending in symbol i, the UE is not expected to be scheduled to transmit a PDSCH starting earlier than the end of the early PDSCH by DCI scheduled by the other cell (i.e., sSCell or SpCell) that ends later than symbol i.

In other words, the sequence of DCI associated with the sSCell and the SpCell is in consistent with the sequence of the PDSCH transmissions corresponding to DCI. In addition, PDSCH transmissions scheduled by different cells should not overlap in time.

In order to facilitate the illustration, we refer to DCI associated with the SpCell as DCI₁ (also called first DCI herein), and refer to DCI associated with the sSCell as DCI₂ (also called second DCI herein). Correspondingly, we refer to the PDSCH scheduled by DCI₁ as PDSCH₁ (also called first PDSCH), and refer to the PDSCH scheduled by DCI₂ as PDSCH₂ (also called second PDSCH). It should be noted that PDSCH₁ and PDSCH₂ are both transmitted in the SpCell.

According to some embodiments, when DCI₁ is earlier than DCI₂, the end of PDSCH₁ should be earlier than the start of PDSCH₂. According to some embodiments, when DCI₁ is later than DCI₂, the start of PDSCH₁ should be later than the end of PDSCH₂. It should be understood that DCI₁ being earlier than DCI₂ could be determined based on the end of DCI₁ being earlier than the end of DCI₂, and DCI₁ being later than DCI₂ could be determined based on the end of DCI₁ being later than the end of DCI₂. These rules may be incorporated into the set of criteria for supporting sSCell scheduling SpCell, which may reduce processing outage probability and complexity of the UE.

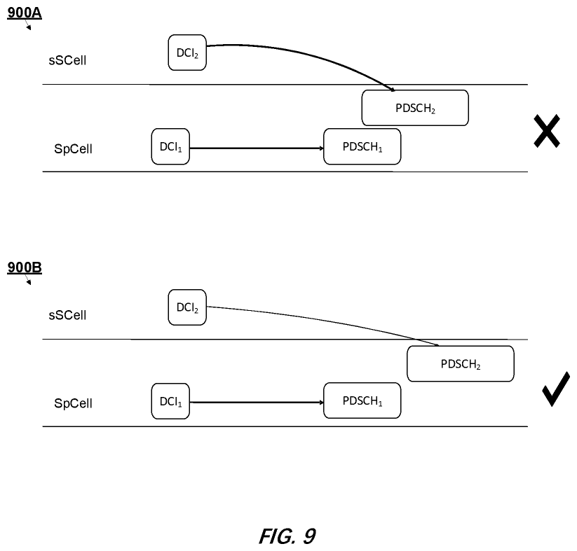

### FIG. 9— Example of Scheduling Restriction on PDSCH

FIG. 9 illustrates two example scenarios, in each of which two PDSCH transmissions are scheduled by the sSCell and the SpCell, respectively. In 900A, DCI₁ associated with the SpCell is earlier than DCI₂ associated with the sSCell, but the end of PDSCH₁ scheduled by DCI₁ is not earlier than the start of PDSCH₂ scheduled by DCI₂, which does not comply with the above criteria. Therefore, the scenario in 900A is not allowed. By contrast, in 900B, DCI₁ associated with the SpCell is earlier than DCI₂ associated with the sSCell, and the end of PDSCH₁ is earlier than the start of PDSCH₂, which complies with the above criteria. Therefore, the scenario in 900B is allowed.

### PUSCH Transmission

Similar to PDSCH transmissions, there are substantially the same scheduling restrictions on PUSCH transmissions. According to some embodiments, for any two HARQ process IDs in a given scheduled cell, if a wireless device (e.g., a UE) is scheduled to start an early PUSCH transmission starting in symbol j by DCI scheduled by the SpCell or the sSCell ending in symbol i, the UE is not expected to be scheduled to transmit a PUSCH starting earlier than the end of the early PUSCH by DCI scheduled by the other cell (i.e., sSCell or SpCell) that ends later than symbol i.

In other words, the sequence of DCI associated with the sSCell and the SpCell is in consistent with the sequence of the PUSCH transmissions corresponding to DCI.

In order to facilitate the illustration, we refer to DCI associated with the SpCell as DCI₁ (also called first DCI herein), and refer to DCI associated with the sSCell as DCI₂ (also called second DCI herein). Correspondingly, we refer to the PUSCH scheduled by DCI₁ as PUSCH₁ (also called first PUSCH), and refer to the PUSCH scheduled by DCI₂ as PUSCH₂ (also called second PUSCH). It should be noted that PUSCH₁ and PUSCH₂ are both transmitted in the SpCell.

According to some embodiments, when DCI₁ is earlier than DCI₂, the end of PUSCH₁ should be earlier than the start of PUSCH₂. According to some embodiments, when DCI₁ is later than DCI₂, the start of PUSCH₁ should be later than the end of PUSCH₂. It should be understood that DCI₁ being earlier than DCI₂ could be determined based on the end of DCI₁ being earlier than the end of DCI₂, and DCI₁ being later than DCI₂ could be determined based on the end of DCI₁ being later than the end of DCI₂. These rules may be incorporated into the set of criteria for supporting sSCell scheduling SpCell, which may reduce processing outage probability and complexity of the UE.

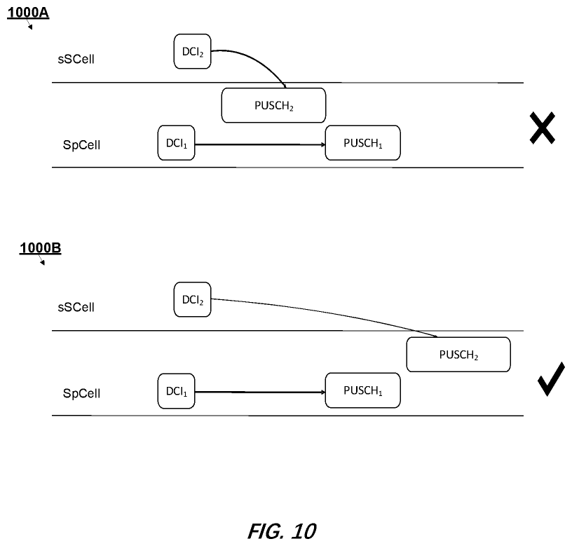

### FIG. 10— Example of Scheduling Restriction on PUSCH

FIG. 10 illustrates two example scenarios, in each of which two PUSCH transmissions are scheduled by the sSCell and the SpCell, respectively. In 1000A, DCI₁ associated with the SpCell is earlier than DCI₂ associated with the sSCell. Although PUSCH₁ scheduled by DCI₁ does not overlap with PUSCH₂ scheduled by DCI₂, PUSCH₁ is later than PUSCH₂. That is, the end of PUSCH₁ is not earlier than the start of PUSCH₂, which does not comply with the above criteria. Therefore, the scenario in 1000A is not allowed. By contrast, in 1000B, DCI₁ associated with the SpCell is earlier than DCI₂ associated with the sSCell, and the end of PUSCH₁ is earlier than the start of PUSCH₂, which complies with the above criteria. Therefore, the scenario in 1000B is allowed.

### HARQ Process

According to some embodiments, when an SpCell is scheduled by an SCell, an HARQ retransmission should not be scheduled from a different cell. Specifically, for a HARQ process, if the SpCell schedules a PDSCH or a PUSCH, the sSCell does not schedule any retransmission of the same HARQ process. For a HARQ process, if the sSCell schedules a PDSCH or a PUSCH, the SpCell does not schedule any retransmission of the same HARQ process. These rules may be incorporated into the set of criteria for supporting sSCell scheduling SpCell.

Generally, HARQ process is semi-statically partitioned among an SpCell and an sSCell. The set of criteria for supporting sSCell scheduling SpCell may include one or more of the following:
A single HARQ process may be only scheduled by either the SpCell or the sSCell;
The semi-static configuration of the SpCell/sSCell mapping to HARQ process may be achieved via RRC or MAC-CE.
The total number of HARQ process (currently 16) that a wireless device (e.g., a UE) needs to support on the SpCell may be further relaxed. However, for each SpCell or sSCell, the number of HARQ processes that can be scheduled may be further restricted.

### USS Configuration

### Non-Fallback DCI Format

In terms of the USS configured when an SpCell is scheduled by an SCell, the following options for non-fallback DCI Formats including DCI Format 0_1, 02, 1_1, 12 may be considered:
Option 1: DCI Format 0_1, 02, 1_1, 1_2 in USS can only be configured in the sSCell;
Option 2: DCI Format 0_1, 02, 1_1, 1_2 in USS can be configured in both of the sSCell and the SpCell. In this regard, the following restrictions is needed: at any given time, a wireless device (e.g., a UE) only monitors non-fallback DCI Format (0_1/2, 1_1/2) on either the SpCell or the sSCell. That is, the non-fallback DCI Formats cannot be monitored in both of the SpCell and the sSCell at the same time. In addition, a cellular base station (e.g., a gNB) may notify the UE via RRC and MAC-CE to select either the SpCell or the sSCell for non-fallback DCI monitoring.

According to some embodiments, Option 1 may be the preferred option. That is, it is preferred that the wireless device may be configured by the cellular base station to monitor one or more of non-fallback DCI Formats configured in the sSCell. This may reduce the complexity of the wireless device.

It will be appreciated that one of the above options is selected and included in a set of criteria for supporting sSCell scheduling SpCell, according to which control information associated with USS including non-fallback DCI Formats is generated at a cellular base station, and sent to a wireless device.

### Fallback DCI Format

In terms of the USS configured when an SpCell is scheduled by an SCell, the following options for fallback DCI Formats including DCI Format 0_0, 1_0 may be considered:
Option 1: DCI Format 0_0, 1_0 cannot be configured in USS when USS is configured in the sSCell;
Option 2: DCI Format 0_0, 1_0 can be configured in USS only when USS is configured in the SpCell. In addition, USS configured in the SpCell cannot contain non-fallback DCI Format 0_1, 02, 11, 12.

According to some embodiments, Option 1 may be the preferred option. That is, it is preferred that the wireless device may be configured by the cellular base station to monitor one or more of fallback DCI Formats which are not configured in USS when USS is configured in the sSCell, since normally fallback DCI formats do not support cross carrier scheduling.

It will be appreciated that one of the above options is selected and included in the set of criteria for supporting sSCell scheduling SpCell, according to which control information associated with USS including fallback DCI Formats is generated at a cellular base station, and sent to a wireless device.

Interaction with Multi-DCI Multi-TRP Operation

For multi-DCI multi-TRP scenario, a wireless device (e.g., a UE) may monitor multiple CORESETs associated with multiple TRPs. Commonly, CORESET is sent from a cellular base station (e.g., a gNB) to a wireless device (e.g., a UE) as an RRC message, and CORESETPoolIndex is configured in each CORESET. In multi-DCI multi-TRP scenario, CORESET could be configured with either CORESETPoolIndex=0 or CORESETPoolIndex=1. It could be understood that CORESETPoolIndex may map to different TRP implicitly. As an example, assuming there are two TRPs, i.e., TRP₁ and TRP₂, CORESETPoolIndex=0 may map to TRP₁ and CORESETPoolIndex=0 may map to TRP₂.

When an SpCell is scheduled by an SCell and Multi-DCI Multi-TRP operation is configured in the SpCell, following options for CORESETPoolIndex configuration can be considered:
Option 1: No restriction, CORESETPoolIndex can be configured as 0 or 1 independently for each CORESET in the SpCell
Option 2:
SpCell can be configured with only CORESETPoolIndex=0
sSCell can be configured with only CORESETPoolIndex=1
Option 3:
SpCell can be configured with only CORESETPoolIndex=0
sSCell can be configured with only CORESETPoolIndex=0, and/or, CORESETPoolIndex=1.

It will be appreciated that one of the above options is selected and included in the set of criteria for supporting sSCell scheduling SpCell, according to which control information including CORESET with configured CORESETPoolIndex is generated at a cellular base station, and sent to a wireless device.

It will be appreciated that the above-mentioned criteria supporting an sSCell scheduling an SpCell may be applied to the scenario of the sSCell and the SpCell in the same Cell Group, and in different Cell Groups.

In the following further exemplary embodiments are provided.

One set of embodiments may include a cellular base station, comprising: at least one antenna; at least one radio coupled to the at least one antenna; and a processor coupled to the at least one radio; wherein the cellular base station is configured to: generate control information in accordance with a set of criteria, wherein the set of criteria supports a special Secondary Cell (sSCell) which is a Secondary Cell (SCell) in scheduling a special Primary Cell (SpCell) which is either a Primary Cell (PCell) or a Primary Secondary Cell (PSCell); and send the control information to a wireless device.

According to some embodiments, the sSCell and the SpCell are in the same Cell Group (CG).

According to some embodiments, the control information is associated with Type3-Physical Downlink Control Channel Common Search Space (Type3-PDCCH CSS) containing DCI Format 25, and the control information causes the wireless device to monitor DCI Format 2_5 in one or more cells where it is configured, and the set of criteria includes one of the following: DCI Format 2_5 is configured in any cell; DCI Format 2_5 is configured only in the SpCell; and DCI Format 2_5 is configured only in the sSCell.

According to some embodiments, the control information is associated with Type3-Physical Downlink Control Channel Common Search Space (Type3-PDCCH CSS) containing DCI Format 2_6, and the control information causes the wireless device to monitor DCI Format 2_6 in one or more cells where it is configured, and the set of criteria includes one of the following: DCI Format 2_6 is configured only in the SpCell; DCI Format 2_6 is configured only in the sSCell; DCI Format 2_6 is configured in either the SpCell or the sSCell, but not both; and DCI Format 2_6 is configured in the sSCell or the sSCell, and both.

According to some embodiments, in response to DCI Format 2_6 being scheduled to the wireless device only in the SpCell, the control information causes the wireless device to one of: (1) dormant in any cell except the SpCell; and (2) dormant in any cell except the sSCell and the SpCell; in response to DCI Format 2_6 being scheduled to the wireless device only in the sSCell, the control information causes the wireless device to one of: (1) dormant in any cell except the sSCell and the SpCell; and (2) dormant in any cell except the sSCell; and in response to DCI Format 2_6 being scheduled to the wireless device in both of the sSCell and the SpCell, the control information causes the wireless device to one of: (1) dormant in any cell except the SpCell; and (2) dormant in any cell except the sSCell and the SpCell.

According to some embodiments, the control information includes first Downlink Control Information (DCI) associated with the SpCell, and second DCI associated with the sSCell, wherein the first DCI schedules a first Physical Downlink Shared Channel (PDSCH) in the SpCell, and the second DCI schedules a second PDSCH in the SpCell, and the set of criteria includes the following: in response to the first DCI being earlier than the second DCI determined based on the end of the first DCI being earlier than the end of the second DCI, the end of the first PDSCH is earlier than the start of the second PDSCH; and in response to the first DCI being later than the second DCI determined based on the end of the first DCI being later than the end of the second DCI, the start of the first PDSCH is later than the end of the second PDSCH.

According to some embodiments, the control information includes first Downlink Control Information (DCI) associated with the SpCell, and second DCI associated with the sSCell, wherein the first DCI schedules a first Physical Uplink Shared Channel (PUSCH) in the SpCell, and the second DCI schedules a second PUSCH in the SpCell, and the set of criteria includes the following: in response to the first DCI being earlier than the second DCI determined based on the end of the first DCI being earlier than the end of the second DCI, the end of the first PUSCH is earlier than the start of the second PUSCH; and in response to the first DCI being later than the second DCI determined based on the end of the first DCI being later than the end of the second DCI, the start of the first PUSCH is later than the end of the second PUSCH.

According to some embodiments, the control information includes Downlink Control Information (DCI) and is associated with a Hybrid Automatic Repeat request (HARQ) process, and the set of criteria includes the following: in response to the DCI being associated with the SpCell scheduling a Physical Downlink Shared Channel (PDSCH) or Physical Uplink Shared Channel (PUSCH), another DCI associated with the sSCell does not schedule a HARQ retransmission of the PDSCH or the PUSCH; and in response to the DCI being associated with the sSCell scheduling a PDSCH or a PUSCH, another DCI associated with the SpCell does not schedule a HARQ retransmission of the PDSCH or the PUSCH.

According to some embodiments, the control information is associated with UE-specific Search Space (USS) containing one or more of non-fallback DCI Formats including DCI Format 0_1, 02, 11 and 1_2, and the control information causes the wireless device to monitor the one or more of non-fallback DCI Formats in one or more cells where they are configured, and the set of criteria includes one of the following: the non-fallback DCI Formats are configured only in sSCell; and the non-fallback DCI Formats are configured in both of the sSCell and the SpCell, while the control information causes the wireless device to monitor the non-fallback DCI Formats in either the SpCell or the sSCell at a given time.

According to some embodiments, the control information is associated with UE-specific Search Space (USS) containing fallback DCI Formats including DCI Format 0_0 and 1_0, and the control information causes the wireless device to monitor the one or more of fallback DCI Formats, and the set of criteria includes one of the following: the fallback DCI Formats are not configured in the USS configured in the sSCell; and the fallback DCI Formats are configured only in the USS configured in the SpCell, wherein the USS configured in the SpCell does not contain non-fallback DCI formats including DCI Format 0_1, 0_2, 1_1 and 1_2.

According to some embodiments, the control information includes CORESET where CORESETPoolIndex is configured, and a value that CORESETPoolIndex is configured as maps to a transmission and reception point (TRP) of multiple TRPs, and

the set of criteria includes one of the following: CORESETPoolIndex is configured as 0 or 1 independently in the SpCell; CORESETPoolIndex is configured as 0 in the SpCell, and CORESETPoolIndex is configured as 1 in the sSCell; and CORESETPoolIndex is configured as 0 in the SpCell, and CORESETPoolIndex is configured as 0 and/or 1 in the sSCell.

Another set of embodiments may include a wireless device, comprising: at least one antenna; at least one radio coupled to the at least one antenna; and a processor coupled to the at least one radio; wherein the wireless device is configured to: receive control information from a cellular base station, wherein the control information is generated in accordance with a set of criteria, and the set of criteria supports a special Secondary Cell (sSCell) which is a Secondary Cell (SCell) in scheduling a special Primary Cell (SpCell) which is either a Primary Cell or a Primary Secondary Cell (PSCell).

According to some embodiments, the sSCell and the SpCell are in the same Cell Group (CG).

According to some embodiments, the control information is associated with Type3-Physical Downlink Control Channel Common Search Space (Type3-PDCCH CSS) containing DCI Format 2_5, and after receiving the control information, the wireless device is further configured to monitor DCI Format 2_5 in one or more cells where it is configured, and the set of criteria includes one of the following: DCI Format 2_5 is configured in any cell; DCI Format 2_5 is configured only in the SpCell; and DCI Format 2_5 is configured only in the sSCell.

According to some embodiments, the control information is associated with Type3-Physical Downlink Control Channel Common Search Space (Type3-PDCCH CSS) containing DCI Format 2_6, and after receiving the control information, the wireless device is further configured to monitor DCI Format 2_6 in one or more cells where it is configured, and the set of criteria includes one of the following: DCI Format 2_6 is configured only in the SpCell; DCI Format 2_6 is configured only in the sSCell; DCI Format 2_6 is configured in either the SpCell or the sSCell, but not both; and DCI Format 2_6 is configured in the sSCell or the sSCell, and both.

According to some embodiments, in response to DCI Format 2_6 being scheduled to the wireless device only in the SpCell, after receiving the control information, the wireless device is further configured to one of: (1) dormant in any cell except the SpCell; and (2) dormant in any cell except the sSCell and the SpCell; in response to DCI Format 2_6 being scheduled to the wireless device only in the sSCell, after receiving the control information, the wireless device is further configured to one of: (1) dormant in any cell except the sSCell and the SpCell; and (2) dormant in any cell except the sSCell; and in response to DCI Format 2_6 being scheduled to the wireless device in both of the sSCell and the SpCell, after receiving the control information, the wireless device is further configured to one of: (1) dormant in any cell except the SpCell; and (2) dormant in any cell except the sSCell and the SpCell.

According to some embodiments, the control information includes first Downlink Control Information (DCI) associated with the SpCell, and second DCI associated with the sSCell, wherein the first DCI schedules a first Physical Downlink Shared Channel (PDSCH) in the SpCell, and the second DCI schedules a second PDSCH in the SpCell, and the set of criteria includes the following: in response to the first DCI being earlier than the second DCI determined based on the end of the first DCI being earlier than the end of the second DCI, the end of the first PDSCH is earlier than the start of the second PDSCH; and in response to the first DCI being later than the second DCI determined based on the end of the first DCI being later than the end of the second DCI, the start of the first PDSCH is later than the end of the second PDSCH.

According to some embodiments, the control information includes first Downlink Control Information (DCI) associated with the SpCell, and second DCI associated with the sSCell, wherein the first DCI schedules a first Physical Uplink Shared Channel (PUSCH) in the SpCell, and the second DCI schedules a second PUSCH in the SpCell, and the set of criteria includes the following: in response to the first DCI being earlier than the second DCI determined based on the end of the first DCI being earlier than the end of the second DCI, the end of the first PUSCH is earlier than the start of the second PUSCH; and in response to the first DCI being later than the second DCI determined based on the end of the first DCI being later than the end of the second DCI, the start of the first PUSCH is later than the end of the second PUSCH.

According to some embodiments, the control information includes Downlink Control Information (DCI) and is associated with a Hybrid Automatic Repeat request (HARQ) process, and the set of criteria includes the following: in response to the DCI being associated with the SpCell scheduling a Physical Downlink Shared Channel (PDSCH) or Physical Uplink Shared Channel (PUSCH), another DCI associated with the sSCell does not schedule a HARQ retransmission of the PDSCH or the PUSCH; and in response to the DCI being associated with the sSCell scheduling a PDSCH or a PUSCH, another DCI associated with the SpCell does not schedule a HARQ retransmission of the PDSCH or the PUSCH.

According to some embodiments, the control information is associated with UE-specific Search Space (USS) containing one or more of non-fallback DCI Formats including DCI Format 0_1, 02, 1_1 and 1_2, and after receiving the control information, the wireless device is further configured to monitor the one or more of non-fallback DCI Formats in one or more cells where they are configured, and the set of criteria includes one of the following: the non-fallback DCI Formats are configured only in sSCell; and the non-fallback DCI Formats are configured in both of the sSCell and the SpCell, while the wireless device is further configured to monitor the non-fallback DCI Formats in either the SpCell or the sSCell at a given time.

According to some embodiments, the control information is associated with UE-specific Search Space (USS) containing one or more of fallback DCI Formats including DCI Format 0_0 and 1_0, and after receiving the control information, the wireless device if further configured to monitor the one or more of fallback DCI Formats in the USS, and the set of criteria includes one of the following: the fallback DCI Formats are not configured in the USS configured in the sSCell; and the fallback DCI Formats are configured only in the USS configured in the SpCell, wherein the USS configured in the SpCell does not contain non-fallback DCI formats including DCI Format 0_1, 02, 1_1 and 1_2.

According to some embodiments, the control information includes CORESET where CORESETPoolIndex is configured, and a value that CORESETPoolIndex is configured as maps to a transmission and reception point (TRP) of multiple TRPs, and the set of criteria includes one of the following: CORESETPoolIndex is configured as 0 or 1 independently in the SpCell; CORESETPoolIndex is configured as 0 in the SpCell, and CORESETPoolIndex is configured as 1 in the sSCell; and CORESETPoolIndex is configured as 0 in the SpCell, and CORESETPoolIndex is configured as 0 and/or 1 in the sSCell.

Yet another set of embodiments may include a method for a cellular base station, comprising: generating control information in accordance with a set of criteria, wherein the set of criteria supports a special Secondary Cell (sSCell) which is a Secondary Cell (SCell) in scheduling a special Primary Cell (SpCell) which is either a Primary Cell (PCell) or a Primary Secondary Cell (PSCell); and sending the control information to a wireless device.

Another exemplary embodiment may include a method for a wireless device, comprising: receiving control information from a cellular base station, wherein the control information is generated in accordance with a set of criteria, and the set of criteria supports a special Secondary Cell (sSCell) which is a Secondary Cell (SCell) in scheduling a special Primary Cell (SpCell) which is either a Primary Cell or a Primary Secondary Cell (PSCell).

Yet another exemplary embodiment may include an apparatus for operating a wireless device, the apparatus comprising: a processor configured to cause the wireless device to: receive control information from a cellular base station, wherein the control information is generated in accordance with a set of criteria, and the set of criteria supports a special Secondary Cell (sSCell) which is a Secondary Cell (SCell) in scheduling a special Primary Cell (SpCell) which is either a Primary Cell or a Primary Secondary Cell (PSCell).

A yet further exemplary embodiment may include a non-transitory computer-readable memory medium storing program instructions, where the program instructions, when executed by a computer system, cause the computer system to perform any or all parts of any of the preceding examples.

A still further exemplary embodiment may include a computer program product, comprising program instructions which, when executed by a computer, cause the computer to perform any or all parts of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method in embodiments described herein, or, any combination of the method embodiments described herein, or, any subset of any of the method embodiments described herein, or, any combination of such subsets.

In some embodiments, a device (e.g., a UE 106 or BS 102) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A cellular base station, comprising:
at least one antenna;
at least one radio coupled to the at least one antenna; and
a processor coupled to the at least one radio;
wherein the cellular base station is configured to:
generate control information in accordance with a set of criteria, wherein the set of criteria supports a special Secondary Cell (sSCell) which is a Secondary Cell (SCell) in scheduling a special Primary Cell (SpCell) which is either a Primary Cell (PCell) or a Primary Secondary Cell (PSCell); and
send the control information to a wireless device.

2. The cellular base station of claim 1, wherein the sSCell and the SpCell are in the same Cell Group (CG).

3. The cellular base station of claim 1, wherein:
the control information is associated with Type3-Physical Downlink Control Channel Common Search Space (Type3-PDCCH CSS) containing DCI Format 2_5, and the control information causes the wireless device to monitor DCI Format 2_5 in one or more cells where it is configured, and
the set of criteria includes one of the following:
DCI Format 2_5 is configured in any cell;
DCI Format 2_5 is configured only in the SpCell; and
DCI Format 2_5 is configured only in the sSCell.

4. The cellular base station of claim 1, wherein:
the control information is associated with Type3-Physical Downlink Control Channel Common Search Space (Type3-PDCCH CSS) containing DCI Format 2_6, and the control information causes the wireless device to monitor DCI Format 2_6 in one or more cells where it is configured, and
the set of criteria includes one of the following:
DCI Format 2_6 is configured only in the SpCell;
DCI Format 2_6 is configured only in the sSCell;
DCI Format 2_6 is configured in either the SpCell or the sSCell, but not both; and
DCI Format 2_6 is configured in the sSCell or the sSCell, and both.

5. The cellular base station of claim 4, wherein:
in response to DCI Format 2_6 being scheduled to the wireless device only in the SpCell, the control information causes the wireless device to one of: (1) dormant in any cell except the SpCell; and (2) dormant in any cell except the sSCell and the SpCell;
in response to DCI Format 2_6 being scheduled to the wireless device only in the sSCell, the control information causes the wireless device to one of: (1) dormant in any cell except the sSCell and the SpCell; and (2) dormant in any cell except the sSCell; and
in response to DCI Format 2_6 being scheduled to the wireless device in both of the sSCell and the SpCell, the control information causes the wireless device to one of: (1) dormant in any cell except the SpCell; and (2) dormant in any cell except the sSCell and the SpCell.

6. The cellular base station of claim 1, wherein:
the control information includes first Downlink Control Information (DCI) associated with the SpCell, and second DCI associated with the sSCell, wherein the first DCI schedules a first Physical Downlink Shared Channel (PDSCH) in the SpCell, and the second DCI schedules a second PDSCH in the SpCell, and
the set of criteria includes the following:
in response to the first DCI being earlier than the second DCI determined based on the end of the first DCI being earlier than the end of the second DCI, the end of the first PDSCH is earlier than the start of the second PDSCH; and
in response to the first DCI being later than the second DCI determined based on the end of the first DCI being later than the end of the second DCI, the start of the first PDSCH is later than the end of the second PDSCH.

7. The cellular base station of claim 1, wherein:
the control information includes first Downlink Control Information (DCI) associated with the SpCell, and second DCI associated with the sSCell, wherein the first DCI schedules a first Physical Uplink Shared Channel (PUSCH) in the SpCell, and the second DCI schedules a second PUSCH in the SpCell, and
the set of criteria includes the following:
in response to the first DCI being earlier than the second DCI determined based on the end of the first DCI being earlier than the end of the second DCI, the end of the first PUSCH is earlier than the start of the second PUSCH; and
in response to the first DCI being later than the second DCI determined based on the end of the first DCI being later than the end of the second DCI, the start of the first PUSCH is later than the end of the second PUSCH.

8. The cellular base station of claim 1, wherein:
the control information includes Downlink Control Information (DCI) and is associated with a Hybrid Automatic Repeat request (HARQ) process, and
the set of criteria includes the following:
in response to the DCI being associated with the SpCell scheduling a Physical Downlink Shared Channel (PDSCH) or Physical Uplink Shared Channel (PUSCH), another DCI associated with the sSCell does not schedule a HARQ retransmission of the PDSCH or the PUSCH; and
in response to the DCI being associated with the sSCell scheduling a PDSCH or a PUSCH, another DCI associated with the SpCell does not schedule a HARQ retransmission of the PDSCH or the PUSCH.

9. The cellular base station of claim 1, wherein:
the control information is associated with UE-specific Search Space (USS) containing one or more of non-fallback DCI Formats including DCI Format 0_1, 0_2, 1_1 and 1_2, and the control information causes the wireless device to monitor the one or more of non-fallback DCI Formats in one or more cells where they are configured, and
the set of criteria includes one of the following:
the non-fallback DCI Formats are configured only in sSCell; and
the non-fallback DCI Formats are configured in both of the sSCell and the SpCell, while the control information causes the wireless device to monitor the non-fallback DCI Formats in either the SpCell or the sSCell at a given time.

10. The cellular base station of claim 1, wherein:
the control information is associated with UE-specific Search Space (USS) containing fallback DCI Formats including DCI Format 0_0 and 1_0, and the control information causes the wireless device to monitor the one or more of fallback DCI Formats, and
the set of criteria includes one of the following:
the fallback DCI Formats are not configured in the USS configured in the sSCell; and
the fallback DCI Formats are configured only in the USS configured in the SpCell, wherein the USS configured in the SpCell does not contain non-fallback DCI formats including DCI Format 0_1, 0_2, 1_1 and 1_2.

11. The cellular base station of claim 1, wherein:
the control information includes CORESET where CORESETPoolIndex is configured, and a value that CORESETPoolIndex is configured as maps to a transmission and reception point (TRP) of multiple TRPs, and
the set of criteria includes one of the following:
CORESETPoolIndex is configured as 0 or 1 independently in the SpCell;
CORESETPoolIndex is configured as 0 in the SpCell, and CORESETPoolIndex is configured as 1 in the sSCell; and
CORESETPoolIndex is configured as 0 in the SpCell, and CORESETPoolIndex is configured as 0 and/or 1 in the sSCell.

12. A wireless device, comprising:
at least one antenna;
at least one radio coupled to the at least one antenna; and
a processor coupled to the at least one radio;
wherein the wireless device is configured to:
receive control information from a cellular base station,
wherein the control information is generated in accordance with a set of criteria, and the set of criteria supports a special Secondary Cell (sSCell) which is a Secondary Cell (SCell) in scheduling a special Primary Cell (SpCell) which is either a Primary Cell or a Primary Secondary Cell (PSCell).

13. The wireless device of claim 12, wherein the sSCell and the SpCell are in the same Cell Group (CG).

14. The wireless device of claim 12,
wherein the control information is associated with Type3-Physical Downlink Control Channel Common Search Space (Type3-PDCCH CSS) containing DCI Format 2_5, and after receiving the control information, the wireless device is further configured to monitor DCI Format 2_5 in one or more cells where it is configured, and
wherein the set of criteria includes one of the following:
DCI Format 2_5 is configured in any cell;
DCI Format 2_5 is configured only in the SpCell; and
DCI Format 2_5 is configured only in the sSCell.

15. The wireless device of claim 12,
wherein the control information is associated with Type3-Physical Downlink Control Channel Common Search Space (Type3-PDCCH CSS) containing DCI Format 2_6, and after receiving the control information, the wireless device is further configured to monitor DCI Format 2_6 in one or more cells where it is configured, and
wherein the set of criteria includes one of the following:
DCI Format 2_6 is configured only in the SpCell;
DCI Format 2_6 is configured only in the sSCell;
DCI Format 2_6 is configured in either the SpCell or the sSCell, but not both; and
DCI Format 2_6 is configured in the sSCell or the sSCell, and both.

16. The wireless device of claim 15, wherein:
in response to DCI Format 2_6 being scheduled to the wireless device only in the SpCell, after receiving the control information, the wireless device is further configured to one of: (1) dormant in any cell except the SpCell; and (2) dormant in any cell except the sSCell and the SpCell;
in response to DCI Format 2_6 being scheduled to the wireless device only in the sSCell, after receiving the control information, the wireless device is further configured to one of: (1) dormant in any cell except the sSCell and the SpCell; and (2) dormant in any cell except the sSCell; and
in response to DCI Format 2_6 being scheduled to the wireless device in both of the sSCell and the SpCell, after receiving the control information, the wireless device is further configured to one of: (1) dormant in any cell except the SpCell; and (2) dormant in any cell except the sSCell and the SpCell.

17. The wireless device of claim 12, wherein:
the control information includes first Downlink Control Information (DCI) associated with the SpCell, and second DCI associated with the sSCell, wherein the first DCI schedules a first Physical Downlink Shared Channel (PDSCH) in the SpCell, and the second DCI schedules a second PDSCH in the SpCell, and
the set of criteria includes the following:
in response to the first DCI being earlier than the second DCI determined based on the end of the first DCI being earlier than the end of the second DCI, the end of the first PDSCH is earlier than the start of the second PDSCH; and
in response to the first DCI being later than the second DCI determined based on the end of the first DCI being later than the end of the second DCI, the start of the first PDSCH is later than the end of the second PDSCH.

18. The wireless device of claim 12, wherein:
the control information includes first Downlink Control Information (DCI) associated with the SpCell, and second DCI associated with the sSCell, wherein the first DCI schedules a first Physical Uplink Shared Channel (PUSCH) in the SpCell, and the second DCI schedules a second PUSCH in the SpCell, and
the set of criteria includes the following:
in response to the first DCI being earlier than the second DCI determined based on the end of the first DCI being earlier than the end of the second DCI, the end of the first PUSCH is earlier than the start of the second PUSCH; and
in response to the first DCI being later than the second DCI determined based on the end of the first DCI being later than the end of the second DCI, the start of the first PUSCH is later than the end of the second PUSCH.

19. The wireless device of claim 12, wherein:
the control information includes Downlink Control Information (DCI) and is associated with a Hybrid Automatic Repeat request (HARQ) process, and
the set of criteria includes the following:
in response to the DCI being associated with the SpCell scheduling a Physical Downlink Shared Channel (PDSCH) or Physical Uplink Shared Channel (PUSCH), another DCI associated with the sSCell does not schedule a HARQ retransmission of the PDSCH or the PUSCH; and
in response to the DCI being associated with the sSCell scheduling a PDSCH or a PUSCH, another DCI associated with the SpCell does not schedule a HARQ retransmission of the PDSCH or the PUSCH.

20.-22. (canceled)

23. A method for a cellular base station, comprising:
generating control information in accordance with a set of criteria, wherein the set of criteria supports a special Secondary Cell (sSCell) which is a Secondary Cell (SCell) in scheduling a special Primary Cell (SpCell) which is either a Primary Cell (PCell) or a Primary Secondary Cell (PSCell); and
sending the control information to a wireless device.

24.-27. (canceled)
